(19) United States
(12) Patent Application Publication
(10) Pub. No.: US 2010/0225930 A1
(43) Pub. Date: Sep. 9, 2010

(54) BEAM IRRADIATION DEVICE AND POSITION DETECTING DEVICE

(75) Inventors: Yoshiaki Maeno, Mizuho-Shi (JP); Atsushi Yamaguchi, Ibi-Gun (JP)

Correspondence Address: DITTHAVONG MORI & STEINER, P.C., 918 Prince Street, Alexandria, VA, 22314, US

(73) Assignees: SANYO Electric Co., Ltd., Moriguchi-shi (JP); SANYO Optec Design Co., Ltd., Bunkyo-ku (JP)

(21) Appl. No.: 12/718,453

(22) Filed: Mar. 5, 2010

(30) Foreign Application Priority Data
Mar. 6, 2009 (JP) 2009-54152

(51) Int. Cl. G01B 11/14; G02B 26/10

(52) U.S. Cl. 356/616; 359/197.1; 359/213.1; 356/615

(57) ABSTRACT

In a beam irradiation device, laser light emitted from a laser light source is entered into a mirror. An actuator pivotally moves the mirror into which laser light is entered, whereby a targeted area is scanned with the laser light. Servo light emitted from a semiconductor laser is entered into a hologram element. The hologram element is pivotally moved with the pivotal movement of the mirror. A diffraction pattern is formed on an exit surface of the hologram element. A photodetector receives servo light transmitted through the hologram element to output a signal depending on a light receiving position of the servo light. The scan width of servo light on the photodetector is increased by a diffraction function of the hologram element.

This application claims priority under 35 U.S.C. Section 119 of Japanese Patent Application No. 2009-54152 filed Mar. 6, 2009, entitled “BEAM IRRADIATION DEVICE AND POSITION DETECTING DEVICE”. The disclosure of the above application is incorporated herein by reference.

### BACKGROUND OF THE INVENTION

1. Field of the Invention

The present invention relates to a beam irradiation device for irradiating laser light onto a targeted area, and more particularly to a beam irradiation device to be loaded in a laser radar system. The present invention also relates to a position detecting device for optically detecting a moved position of a moving section using servo light.

2. Disclosure of Related Art

In recent years, a laser radar system for irradiating laser light in a forward direction with respect to a driving direction to detect presence or absence of an obstacle or a distance to the obstacle in a targeted area, based on a state of reflection light of the laser light, has been loaded in a family automobile or the like to enhance security in driving. Generally, the laser radar system is so configured as to scan a targeted area with laser light to detect presence or absence of an obstacle at each of scanning positions, based on presence or absence of reflection light at each of the scanning positions. The laser radar system is also configured to detect a distance to the obstacle at each of the scanning positions, based on a required time from an irradiation timing of laser light to a light receiving timing of reflection light at each of the scanning positions.

It is necessary to properly scan a targeted area with laser light, and properly detect each of scanning positions of laser light to enhance detection precision of the laser radar system. Heretofore, there have been known scan mechanisms using laser light, such as a scan mechanism incorporated with a polygon mirror, and a scan mechanism incorporated with a scanning lens to be driven two-dimensionally. In addition, there has also been known a scan mechanism incorporated with a pivotal mirror for making laser light to scan a scanning area.

In the scan mechanism incorporated with a pivotal mirror, the mirror is supported to be driven about two axes, and the mirror is pivotally moved about the respective drive axes by an electromagnetic driving force between a coil and a magnet. Laser light is entered into the mirror in an oblique direction, and the mirror is driven about each of the two drive axes, whereby reflection light of laser light from the mirror scans a targeted area in a two-dimensional direction.

In the scan mechanism having the above arrangement, a scanning position of laser light in a targeted area has a one-to-one correspondence to a pivotal position of the mirror. Accordingly, the scanning position of laser light can be detected by detecting the pivotal position of the mirror. In the above arrangement, the pivotal position of the mirror can be detected by e.g. detecting a pivotal position of another member which is pivotally moved with the mirror.

FIG. 10 is a diagram showing an example of an arrangement for detecting a pivotal position of another member. In FIG. 10, the reference numeral 601 indicates a semiconductor laser, 602 indicates a parallel flat plate-shaped light transmissive member, and 603 indicates a PSD (Position Sensing Device). Laser light emitted from the semiconductor laser 601 is refracted by the light transmissive member 602 disposed with a certain inclination with respect to an optical axis of laser light, and is received by the PSD 603. In this arrangement, when the light transmissive member 602 is pivotally moved in the direction of the arrow in FIG. 10, the optical path of laser light is changed as shown by the dotted line in FIG. 10, and the light receiving position of laser light on the PSD 603 is also changed. Accordingly, the pivotal position of the light transmissive member 602 can be detected based on the light receiving position of laser light to be detected on the PSD 603.

However, in the arrangement shown in FIG. 10, it is necessary to increase a thickness of the light transmissive member 602 in order to increase a displacement amount of laser light to be entered into the PSD 603, and to enhance precision of position detection of laser light. There is a problem that an increase in the thickness of the light transmissive member 602 may increase a weight of the light transmissive member 602, and increase the load of a movable section for driving the light transmissive member 602.

### SUMMARY OF THE INVENTION

A first aspect of the invention is directed to a beam irradiation device. The beam irradiation device according to the first aspect includes: a laser light source which emits laser light; an actuator which pivotally moves an optical element into which the laser light is entered to thereby scan a targeted area with the laser light; a servo light source which emits servo light; a transparent member which is pivotally moved with the pivotal movement of the optical element, and into which the servo light is entered; a photodetector which receives the servo light transmitted through the transparent member to output a signal depending on a light receiving position of the servo light; and a diffracting portion which is pivotally moved with the transparent member, and diffracts the servo light in a pivotal direction of the transparent member.

A second aspect of the invention is directed to a position detecting device for detecting a pivotal position of an object. The position detecting device according to the second aspect includes: a servo light source which emits servo light; a transparent member which is pivotally moved with a pivotal movement of the object, and into which the servo light is entered; a photodetector which receives the servo light transmitted through the transparent member to output a signal representing a light receiving position of the servo light; and a diffracting portion which is pivotally moved with the transparent member, and diffracts the servo light in a pivotal direction of the transparent member.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams showing an arrangement of a mirror actuator in an embodiment of the invention.

FIG. 2 is a diagram showing an optical system in a beam irradiation device embodying the invention.

FIGS. 3A and 3B are diagrams showing a servo optical system in the beam irradiation device in the embodiment.

FIGS. 4A and 4B are diagrams showing an arrangement of a PSD in the embodiment.

FIGS. 5A and 5B are diagrams for describing a method for generating a position detection signal in the embodiment.

FIG. 6 is a diagram showing a circuit configuration of the beam irradiation device in the embodiment.

FIGS. 7A through 7D are diagrams for describing incident states of servo light in the embodiment.

FIGS. 8A through 8C are diagrams showing a modification of the servo optical system in the embodiment.

FIG. 9 is a diagram showing a modification of a photodetector in the embodiment.

FIG. 10 is a diagram for describing a position detecting method using a PSD.

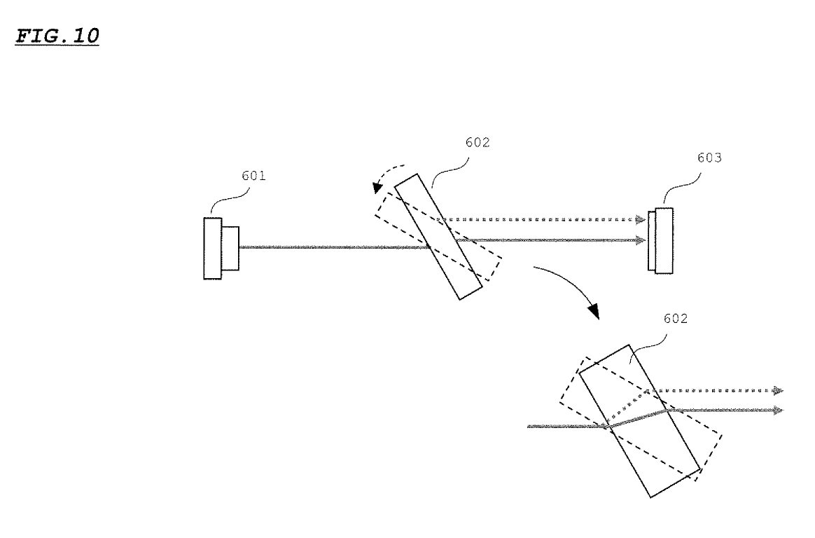

The drawings are provided mainly for describing the present invention, and do not limit the scope of the present invention.

### DESCRIPTION OF PREFERRED EMBODIMENTS

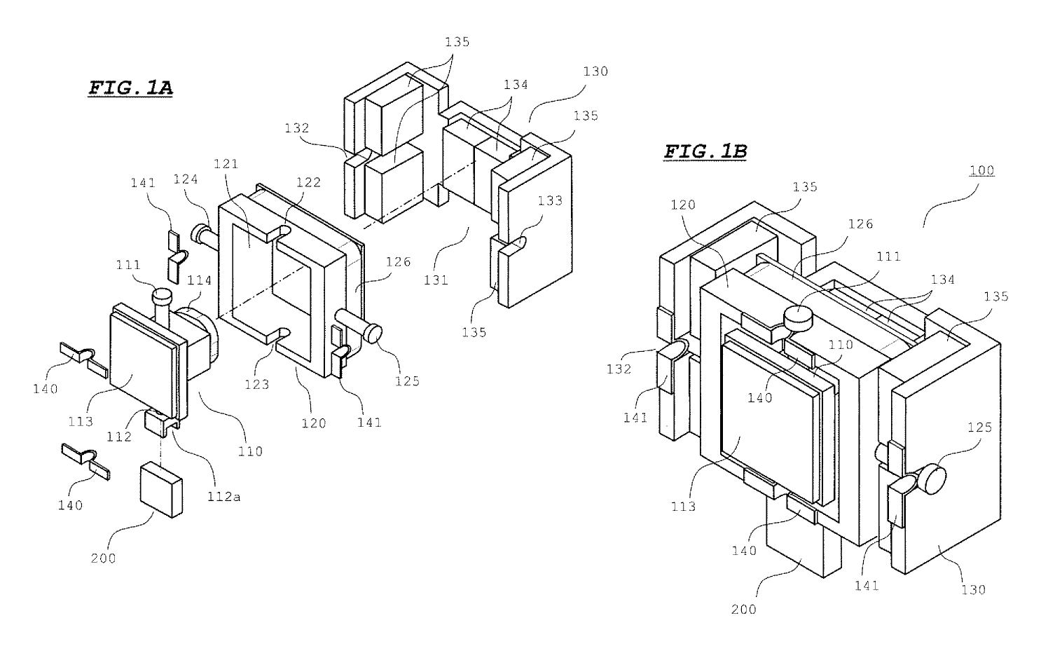

FIGS. 1A and 1B are diagrams showing an arrangement of a mirror actuator 100 in an embodiment of the invention. FIG. 1A is an exploded perspective view of the mirror actuator 100, and FIG. 1B is a perspective view of the mirror actuator 100 in an assembled state.

Referring to FIG. 1A, the reference numeral 110 indicates a mirror holder. The mirror holder 110 is formed with a support shaft 111 having a retainer at an end thereof, and a support shaft 112 having a bracket portion 112a at an end thereof. The bracket portion 112a has a recess of a size substantially equal to a thickness of a hologram element 200, and an upper part of the hologram element 200 is mounted in the recess. A flat plate-shaped mirror 113 is mounted on a front surface of the mirror holder 110, and a coil 114 is mounted on a rear surface thereof. The coil 114 is wound in a rectangular shape.

As described above, the hologram element 200 of a parallel flat plate shape is mounted on the support shaft 112 through the bracket portion 112a. In this example, the hologram element 200 is mounted on the support shaft 112 in such a manner that two flat surfaces of the hologram element 200 are aligned in parallel to a mirror surface of the mirror 113.

The reference numeral 120 indicates a movable frame which pivotally supports the mirror holder 110 about axes of the support shafts 111 and 112. The movable frame 120 is formed with an opening 121 for accommodating the mirror holder 110 therein. The movable frame 120 is also formed with grooves 122 and 123 to be engaged with the support shafts 111 and 112 of the mirror holder 110. Support shafts 124 and 125 each having a retainer at an end thereof are formed on side surfaces of the movable frame 120, and a coil 126 is mounted on a rear surface of the movable frame 120. The coil 126 is wound in a rectangular shape.

The reference numeral 130 indicates a fixed frame which pivotally supports the movable frame 120 about axes of the support shafts 124 and 125. The fixed frame 130 is formed with a recess 131 for accommodating the movable frame 120 therein. The fixed frame 130 is also formed with grooves 132 and 133 to be engaged with the support shafts 124 and 125 of the movable frame 120. Magnets 134 for applying a magnetic field to the coil 114, and magnets 135 for applying a magnetic field to the coil 126 are mounted on inner surfaces of the fixed frame 130. The grooves 132 and 133 each extends from a front surface of the fixed frame 130 to a position in a clearance between the upper and lower two magnets 135.

The reference numeral 140 indicates a pressing plate for pressing the support shafts 111 and 112 in a rearward direction to prevent the support shafts 111 and 112 of the mirror holder 110 from disengaging from the grooves 122 and 123 of the movable frame 120. The reference numeral 141 indicates a pressing plate for pressing the support shafts 124 and 125 in the rearward direction to prevent the support shafts 124 and 125 of the movable frame 120 from disengaging from the grooves 132 and 133 of the fixed frame 130.

In the case where the mirror actuator 100 is assembled, the support shafts 111 and 112 of the mirror holder 110 are engaged in the grooves 122 and 123 of the movable frame 120, and the pressing plate 140 is mounted on a front surface of the movable frame 120 in such a manner as to press front surfaces of the support shafts 111 and 112. Accordingly, the mirror holder 110 is pivotally supported on the movable frame 120.

After the mirror holder 110 is mounted on the movable frame 120 in the above-described manner, the support shafts 124 and 125 of the movable frame 120 are engaged in the grooves 132 and 133 of the fixed frame 130, and the pressing plate 141 is mounted on the front surface of the fixed frame 130 in such a manner as to press front surfaces of the support shafts 132 and 133. Accordingly, the movable frame 120 is pivotally mounted on the fixed frame 130. Thus, the mirror actuator 100 is assembled.

As the mirror holder 110 is pivotally rotated with respect to the movable frame 120 about the axes of the support shafts 111 and 112, the mirror 113 is pivotally rotated. Further, as the movable frame 120 is pivotally rotated with respect to the fixed frame 130 about the axes of the support shafts 124 and 125, the mirror holder 110 is pivotally rotated, and as a result, the mirror 113 is pivotally rotated with the mirror holder 110. Thus, the mirror holder 110 is pivotally supported in a two-dimensional direction about the axes of the support shafts 111 and 112, and the support shafts 124 and 125 orthogonal to each other, and the mirror 113 is pivotally rotated in the two-dimensional direction in accordance with the pivotal rotation of the mirror holder 110. During the pivotal rotation, the hologram element 200 mounted on the support shaft 112 is also pivotally rotated in accordance with the pivotal rotation of the mirror 113.

In the assembled state shown in FIG. 1B, the positions and the polarities of the two magnets 134 are adjusted in such a manner that a force for pivotally rotating the mirror holder 110 about the axes of the support shafts 111 and 112 is generated by application of a current to the coil 114. Accordingly, in response to application of a current to the coil 114, the mirror holder 110 is pivotally rotated about the axes of the support shafts 111 and 112 by the electromagnetic driving force generated in the coil 114.

Further, in the assembled state shown in FIG. 1B, the positions and the polarities of the two magnets 135 are adjusted in such a manner that a force for pivotally rotating the movable frame 120 about the axes of the support shafts 124 and 125 is generated by application of a current to the coil 126. Accordingly, in response to application of a current to the coil 126, the movable frame 120 is pivotally rotated about the axes of the support shafts 124 and 125 by the electromagnetic driving force generated in the coil 126, and the hologram element 200 is pivotally rotated in accordance with the pivotal rotation of the movable frame 120.

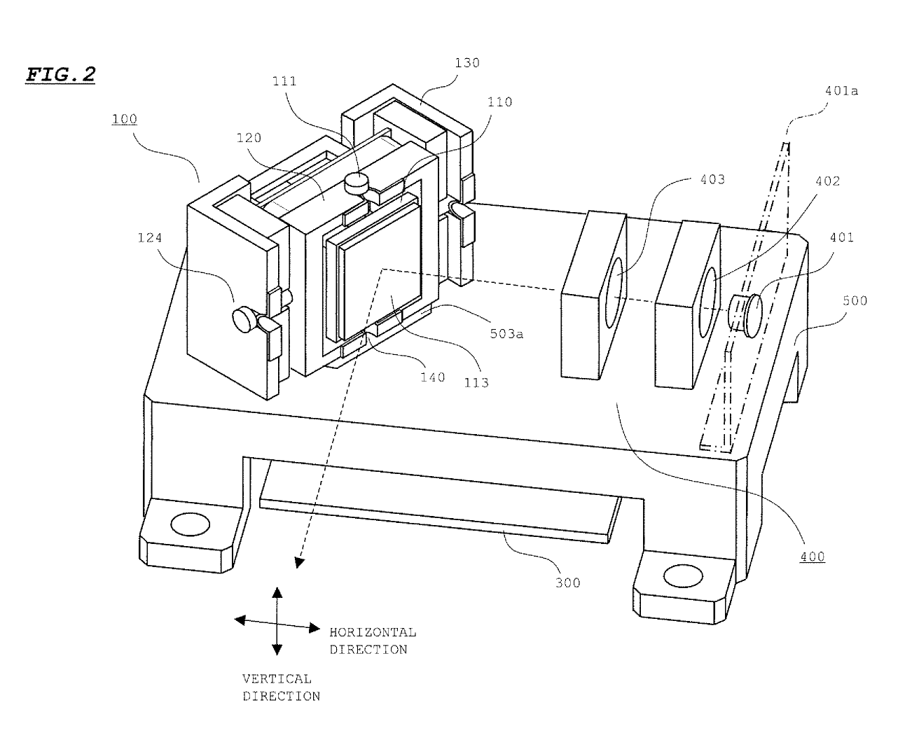

FIG. 2 is a diagram showing an arrangement of an optical system in a state that the mirror actuator 100 is mounted.

Referring to FIG. 2, the reference numeral 500 indicates a base plate for supporting an optical system. The base plate 500 is formed with an opening 503a at a position where the mirror actuator 100 is installed. The mirror actuator 100 is mounted on the base plate 500 in such a manner that the hologram element 200 is received in the opening 503a.

An optical system 400 for guiding laser light to the mirror 113 is mounted on a top surface of the base plate 500. The optical system 400 includes a laser light source 401, and lens 402 and 403 for beam shaping. The laser light source 401 is mounted on a substrate 401a for a laser light source, and the substrate 401a is provided on the top surface of the base plate 500.

Laser light emitted from the laser light source 401 is subjected to convergence in a horizontal direction and a vertical direction by the lenses 402 and 403, respectively. The lenses 402 and 403 are designed in such a manner that the beam shape in a targeted area (e.g. an area defined at a position 100 m away in a forward direction from a beam exit port of a beam irradiation device) has predetermined dimensions (e.g. dimensions of about 2 m in the vertical direction and 1 m in the horizontal direction).

The lens 402 is a cylindrical lens having a lens function in the vertical direction, and the lens 403 is an aspherical lens for emitting laser light as substantially parallel light. A beam emitted from a laser light source has different divergence angles from each other in the vertical direction and the horizontal direction. The first lens 402 changes a ratio between divergence angles of laser light in the vertical direction and the horizontal direction. The second lens 403 changes magnifications of divergence angles (both in the vertical direction and the horizontal direction) of an emitted beam.

Laser light transmitted through the lenses 402 and 403 is entered into the mirror 113 of the mirror actuator 100, and reflected on the mirror 113 toward a targeted area. The targeted area is scanned in the two-dimensional direction with the laser light when the mirror 113 is two-dimensionally driven by the mirror actuator 100.

The mirror actuator 100 is disposed at such a position that laser light from the lens 403 is entered into the mirror surface of the mirror 113 at an incident angle of 45 degrees with respect to the horizontal direction, when the mirror 113 is set to a neutral position. The term “neutral position” indicates a position of the mirror 113, wherein the mirror surface is aligned in parallel to the vertical direction, and laser light is entered into the mirror surface at an incident angle of 45 degrees with respect to the horizontal direction.

A circuit board 300 is provided underneath the base plate 500. Further, circuit boards 301 and 302 are provided on a back surface and a side surface of the base plate 500.

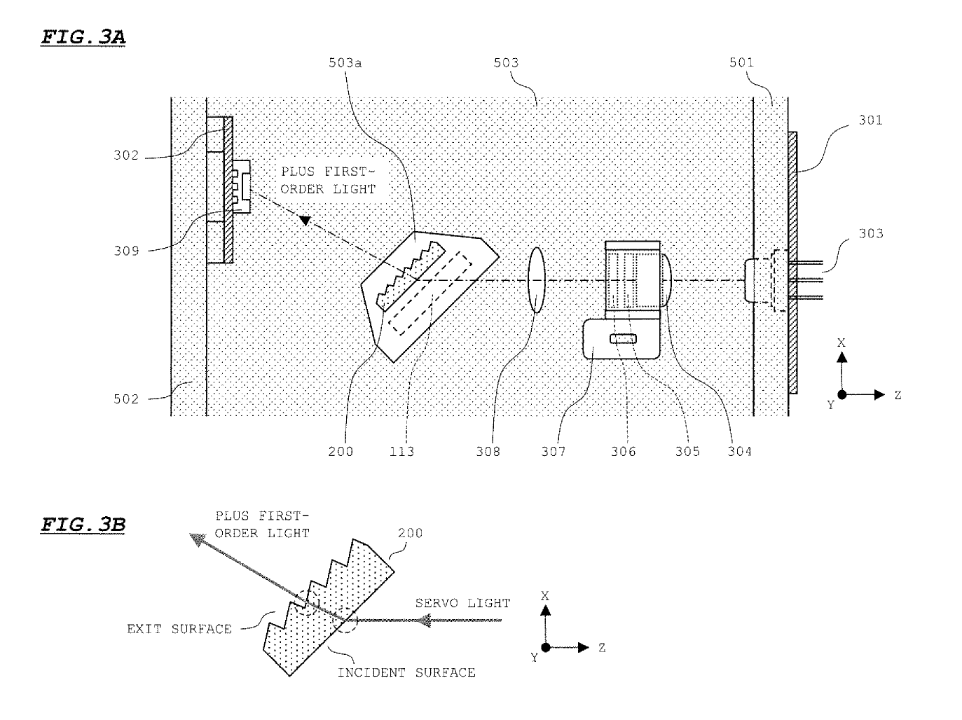

FIG. 3A is a partial plan view of the base plate 500, viewed from the back side of the base plate 500. FIG. 3A shows a part of the back surface of the base plate 500, i.e. a vicinity of the position where the mirror actuator 100 is mounted.

As shown in FIG. 3A, walls 501 and 502 are formed on the periphery of the back surface of the base plate 500. A flat surface 503 lower than the walls 501 and 502 is formed in a middle portion of the back surface of the base plate 500 with respect to the walls 501 and 502. The wall 501 is formed with an opening for receiving a semiconductor laser 303. The circuit board 301 loaded with the semiconductor laser 303 is attached to an outer side surface of the wall 501 in such a manner that the semiconductor laser 303 is received in the opening of the wall 501. Further, the circuit board 302 loaded with a PSD 309 is attached to a position near the wall 502. The PSD 309 has a light receiving surface whose width in X-axis direction is larger than that in Y-axis direction in FIG. 3A.

A light collecting lens 304, an aperture 305, and a ND (neutral density) filter 306 are mounted on the flat surface 503 on the back surface of the base plate 500 by an attachment member 307. The flat surface 503 is formed with an opening 503a, and the hologram element 200 mounted on the mirror actuator 100 is projected from the back surface of the base plate 500 through the opening 503a.

The hologram element 200 is set to such a position that the two flat surfaces of the hologram element 200 are aligned in parallel to the vertical direction, and are inclined with respect to an optical axis of emission light from the semiconductor laser 303 by 45 degrees, when the mirror 113 of the mirror actuator 100 is set to the neutral position. Further, a blazed diffraction pattern for diffracting servo light in plus direction (upward direction) of X-axis in an in-plane direction of X-Z plane, when the mirror 113 is set to the neutral position, is integrally formed on the exit surface of the hologram element 200.

Laser light (hereinafter, called as “servo light”) emitted from the semiconductor laser 303 transmitted through the light collecting lens 304 has the beam diameter thereof reduced by the aperture 305, and has the light intensity thereof reduced by the ND filter 306. Further, the servo light is converted into parallel light by the collimator lens 308, and then, entered into the hologram element 200.

Servo light to be entered into the hologram element 200 is refracted and diffracted by the hologram element 200, as will be described later. Accordingly, plus first-order light of servo light generated by the refraction function and the diffraction function is emitted from the hologram element 200 in a state that the propagating direction thereof is changed, as shown in FIG. 3A, and is received on the PSD 309. The PSD 309 outputs a position detection signal depending on a light receiving position of the plus first-order light.

FIG. 3B is a diagram schematically showing a refraction function and a diffraction function of the hologram element 200.

Servo light to be entered into the hologram element 200 is at first refracted on an incident surface of the hologram element 200. Then, the refracted servo light is diffracted and refracted on an exit surface of the hologram element 200. Specifically, servo light is divided into zero-order light (not shown), and plus first-order light diffracted in plus direction (upward direction) of X-axis on the exit surface of the hologram element 200 by the aforementioned diffraction pattern. Simultaneously, the zero-order light and the plus first-order light are respectively refracted on the exit surface of the hologram element 200, and emitted from the exit surface of the hologram element 200. As a result of the above operation, the plus first-order light is emitted from the hologram element 200 in a state that the propagating direction thereof in plus direction (upward direction) of X-axis is further changed, as compared with the servo light before incidence into the hologram element 200.

The diffraction efficiency and the diffraction angle of the hologram element 200 are respectively determined by the blaze height and the pitch width of the diffraction pattern. Accordingly, it is necessary to set the positions of the diffraction pattern and the optical system in advance so that only the plus first-order light is properly received on the PSD 309. Further, it is desirable to set the diffraction pattern of the hologram element 200 in such a manner that the diffraction efficiency of plus first-order light is maximized. The above arrangement enables to obtain a position detection signal of high precision, because the light amount of plus first-order light to be received on the PSD 309 is increased.

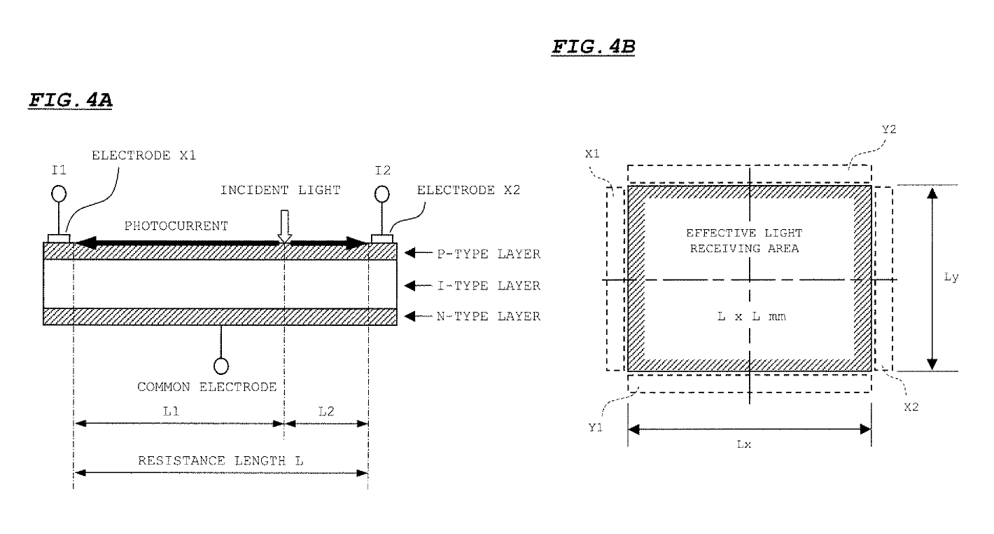

FIG. 4A is a diagram (a side sectional view) showing an arrangement of the PSD 309, and FIG. 4B is a diagram showing a light receiving surface of the PSD 309.

Referring to FIG. 4A, the PSD 309 has such a structure that a P-type resistive layer serving as a light receiving surface and a resistive layer is formed on a surface of an N-type high resistive silicon substrate. Electrodes X1 and X2 for outputting a photocurrent in the horizontal direction on the plane of FIG. 4B, and electrodes Y1 and Y2 (not shown in FIG. 4A) for outputting a photocurrent in the vertical direction on the plane of FIG. 4B are formed on a surface of the resistive layer. A common electrode is formed on the back surface of the substrate.

When laser light is irradiated onto the light receiving surface of the substrate, an electric charge proportional to a light amount is generated at an irradiated position on the light receiving surface. The electric charge is received by the resistive layer as a photocurrent, and the photocurrent is divided in inverse proportion to a distance to the respective corresponding electrodes, and outputted from the electrodes X1, X2, Y1, and Y2. In this example, currents to be outputted from the electrode X1, X2, Y1, and Y2 each has a magnitude obtained by dividing a photocurrent in inverse proportion to a distance from the laser light irradiated position to the respective corresponding electrodes. Thus, the light irradiated position on the light receiving surface can be detected, based on current values to be outputted from the electrodes X1, X2, Y1, and Y2.

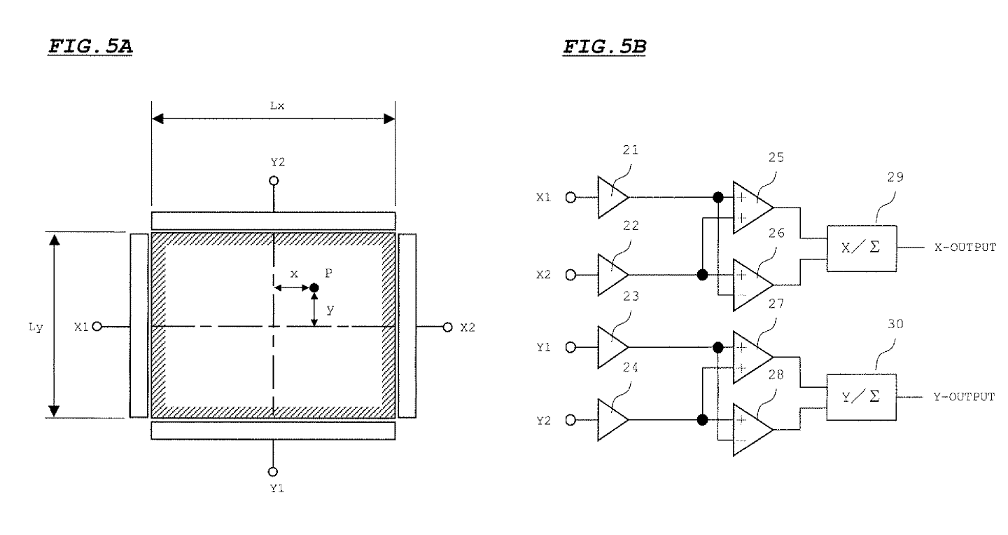

For instance, let it be assumed that plus first-order light is irradiated to a position P in FIG. 5A. In this case, a coordinate (x,y) of the position P, with a center position on the light receiving surface being defined as a reference point, is calculated by e.g. the following equations (1) and (2):

$$\begin{matrix}\frac{I x 2 - I x 1}{I x 2 + I x 1} = \frac{2 x}{L x} & ( 1 ) \\ \frac{I y 2 - I y 1}{I y 2 + I y 1} = \frac{2 y}{L y} & ( 2 )\end{matrix}$$

where Ix1, Ix2, Iy1, and Iy2 are amounts of current to be outputted from the electrodes X1, X2, Y1, and Y2, respectively, and Lx and Ly are distances between the electrodes in X direction and Y direction, respectively.

FIG. 5B is a diagram showing an arrangement of a computation circuit for realizing the above equations (1) and (2). The current signals Ix1, Ix2, Iy1, and Iy2 to be outputted from the electrodes X1, X2, Y1, and Y2 are amplified by amplifiers 21, 22, 23, and 24, respectively. Then, computations (Ix2+Ix1) and (Iy2+Iy1) are performed by adder circuits 25 and 27, respectively. Then, computations (Ix2−Ix1) and (Iy2−Iy1) are performed by subtraction circuits 26 and 28, respectively. Then, divisions as expressed by the left-hand members of the equations (1) and (2) are performed by divider circuits 29 and 30, respectively. Thus, position detection signals indicating an X-directional position (2x/Lx) and a Y-directional position (2y/Ly) at the light receiving position P of plus first-order light are outputted from the divider circuits 29 and 30, respectively.

FIG. 5B shows a circuit configuration for performing computations with respect to the current signals Ix1, Ix2, Iy1, and Iy2. Alternatively, position detection signals may be generated by performing computations based on voltage signals obtained by I/V conversion of the current signals Ix1, Ix2, Iy1, and Iy2 in the similar manner as described above.

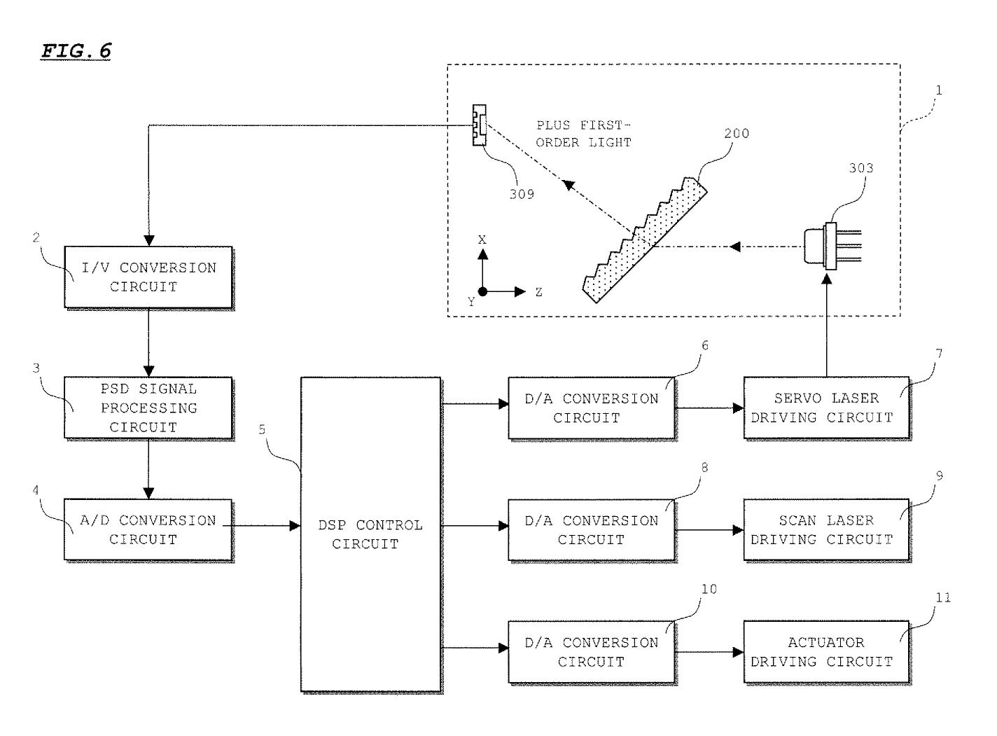

FIG. 6 is a diagram showing a circuit configuration of the beam irradiation device in the embodiment. To simplify the description, the primary elements of the servo optical system 1 shown in FIG. 3A are shown in FIG. 6.

As shown in FIG. 6, the beam irradiation device includes an I/V conversion circuit 2, a PSD signal processing circuit 3, an A/D conversion circuit 4, a DSP (Digital Signal Processor) control circuit 5, D/A conversion circuits 6, 8, and 10, a servo laser driving circuit 7, a scan laser driving circuit 9, and an actuator driving circuit 11.

In the servo optical system 1, as described above, after the servo light emitted from the semiconductor laser 303 is refracted and diffracted by the hologram element 200, the plus first-order light is entered into the light receiving surface of the PSD 309. Accordingly, current signals (current signals to be outputted from the electrodes X1, X2, Y1, and Y2 shown in FIG. 5A) depending on a light receiving position of the plus first-order light are outputted from the PSD 309 and inputted to the I/V conversion circuit 2.

The I/V conversion circuit 2 converts the inputted current signals into voltage signals, and outputs the voltage signals to the PSD signal processing circuit 3. The PSD signal processing circuit 3 generates a signal representing a light receiving position of the plus first-order light based on the inputted voltage signals by the computations described referring to FIG. 5B, and outputs the signal to the A/D conversion circuit 4. In the above circuit configuration, current signals from the respective corresponding electrodes of the PSD 309 are converted into voltage signals, and a position detection signal representing a light receiving position is generated based on the voltage signals after I/V conversion. The A/D conversion circuit 4 converts the inputted position detection signal into a digital signal, and outputs the digital signal to the DSP control circuit 5.

The DSP control circuit 5 detects a scanning position of laser light within a targeted area, based on the inputted position detection signal representing a light receiving position of the plus first-order light, controls driving of the mirror actuator 100, and executes e.g. drive-control of a laser light source 401.

Specifically, the DSP control circuit 5 outputs, to the scan laser driving circuit 9 through the D/A conversion circuit 8, a pulse drive signal at a timing when a scanning position of laser light within a targeted area reaches a predetermined position. Accordingly, the laser light source 401 emits pulse light to irradiate the laser light onto the targeted area. Further, the DSP control circuit 5 outputs, to the actuator driving circuit 11 through the D/A conversion circuit 10, a servo signal for tracing the scanning position of laser light within the targeted area along a predetermined trajectory. In response to receiving the servo signal, the actuator driving circuit 11 drives the mirror actuator 100 to scan the targeted area in such a manner that the laser light follows the predetermined trajectory.

Further, the DSP control circuit 5 outputs a control signal to the servo laser driving circuit 7 through the D/A conversion circuit 6. Accordingly, the semiconductor laser 303 in the servo optical system 1 constantly emits light at a predetermined power level.

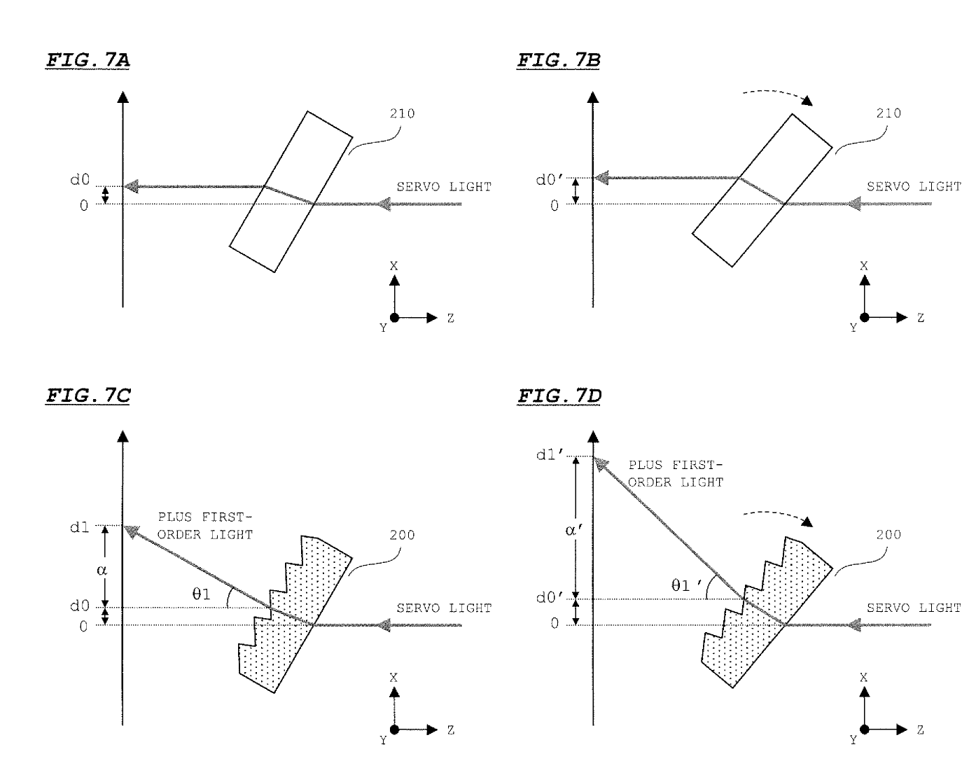

FIGS. 7A through 7D are diagrams showing incident states of servo light with respect to the PSD 309.

FIGS. 7A and 7B are diagrams showing states of servo light, in the case (a comparative example) where a parallel flat plate-shaped transparent member 210 having substantially the same refractive index and thickness as those of the hologram element 200 is used. A diffraction pattern is not formed on an exit surface of the transparent member 210.

FIGS. 7C and 7D are diagrams showing states of servo light, in the case where the hologram element 200 in the embodiment is used. FIGS. 7A through 7D each shows a coordinate axis in X-axis direction in X-Y plane (hereinafter, called as a “light receiving plane”) substantially equivalent to the light receiving surface of the PSD 309, with an incident position of propagating servo light being defined as a reference point.

In the case of FIG. 7A, as shown in FIG. 7A, servo light to be entered into the transparent member 210 is entered at a position d0 on the light receiving plane by a refraction function of the transparent member 210. In the case of FIG. 7B, as shown in FIG. 7B, servo light to be entered into the transparent member 210 is entered at a position d0′ on the light receiving plane. Accordingly, in the comparative example, in the case where the transparent member 210 is pivotally moved from the state shown in FIG. 7A to the state shown in FIG. 7B, a varied amount Δd0 of the incident position on the light receiving plane in X-axis direction is expressed by the following equation (3):

Δd0=d0′−d0 (3)

Next, in the case of FIG. 7C, as described above, servo light to be entered into the hologram element 200 is refracted and diffracted by the hologram element 200. Specifically, servo light is refracted on the incident surface of the hologram element 200. By the refraction function, the exit position of servo light from the hologram element 200 in X-axis direction is set to d0, which is identical to the case shown in FIG. 7A. Servo light is further refracted and diffracted on the exit surface of the hologram element 200. Accordingly, as shown in FIG. 7C, plus first-order light generated by the refraction function and the diffraction function is entered into the position d1 on the light receiving plane.

In the case of FIG. 7D, the exit position of servo light from the hologram element 200 in X-axis direction is set to d0′, which is identical to the case shown in FIG. 7A. Servo light is further refracted and diffracted on the exit surface of the hologram element 200. Accordingly, as shown in FIG. 7D, plus first-order light generated by the refraction function and the diffraction function is entered into the position d1' on the light receiving plane.

Accordingly, a varied amount Δd1 of the incident position on the light receiving plane in X-axis direction, in the case where the hologram element 200 is pivotally moved from the state shown in FIG. 7C to the state shown in FIG. 7D, becomes equal to the sum of a varied amount of a light receiving position free of diffraction i.e. the varied amount expressed by the equation (3), and a varied amount of a light receiving position only resulting from diffraction. In other words, the varied amount Δd1 is expressed by the following equation (4):

Δd1=(d0′−d0)+(α′−α)=Δd0+(α′−α) (4)

where α is a difference between d1 and d0, and α′ is a difference between d1′ and d0′.

In this example, referring to FIGS. 7C and 7D, assuming that plus first-order light is entered into X-Z plane respectively with inclination angles θ1 and θ1′ with respect to Z-axis, the relation between the two inclination angles is set to θ1<θ1′ by the pivotal movement of the hologram element 200, and the function on the exit surface of the hologram element 200. Accordingly, the varied amount (α′−α) only resulting from diffraction, which is expressed in the equation (4) becomes (α′−α)>0. Consequently, in the case of FIGS. 7C and 7D, as compared with the case of FIGS. 7A and 7B, the scan width of servo light (plus first-order light) in X-axis direction is increased.

As described above, according to the embodiment, since the scan width of servo light (plus first-order light) in X-axis direction is increased, the resolution performance at a scanning position in X-axis direction can be enhanced. Accordingly, detection precision on a light receiving position of servo light in X-axis direction can be enhanced. Further, even if the thickness of the hologram element 200 is small, the pivotal position of the hologram element 200 can be detected substantially with the same precision as in a case of using a transparent member having a large thickness. Accordingly, the embodiment enables to precisely detect a scanning position of laser light within a targeted area, using the lightweight and thin hologram element 200.

The beam irradiation device in the embodiment is suitably applied to e.g. a laser radar system to be loaded in a vehicle. Normally, a targeted area in a laser radar system to be loaded in a vehicle has a longer size in the horizontal direction, and it is necessary to accurately detect an irradiated position of scanning laser light in the horizontal direction. Accordingly, in the case where the beam irradiation device of the embodiment is mounted in a laser radar system to be loaded in a vehicle, as shown in FIGS. 2 and 3A, aligning the horizontal direction in X-axis direction enables to accurately detect an irradiated position of scanning laser light in the horizontal direction, and enhance detection precision of an object in a targeted area.

The embodiment of the invention has been described as above. The invention, however, is not limited to the embodiment, and may be modified in various ways other than the above.

For instance, a semiconductor laser is used as a light source for servo light in the embodiment. Alternatively, an LED (Light Emitting Diode) may be used in place of the semiconductor laser.

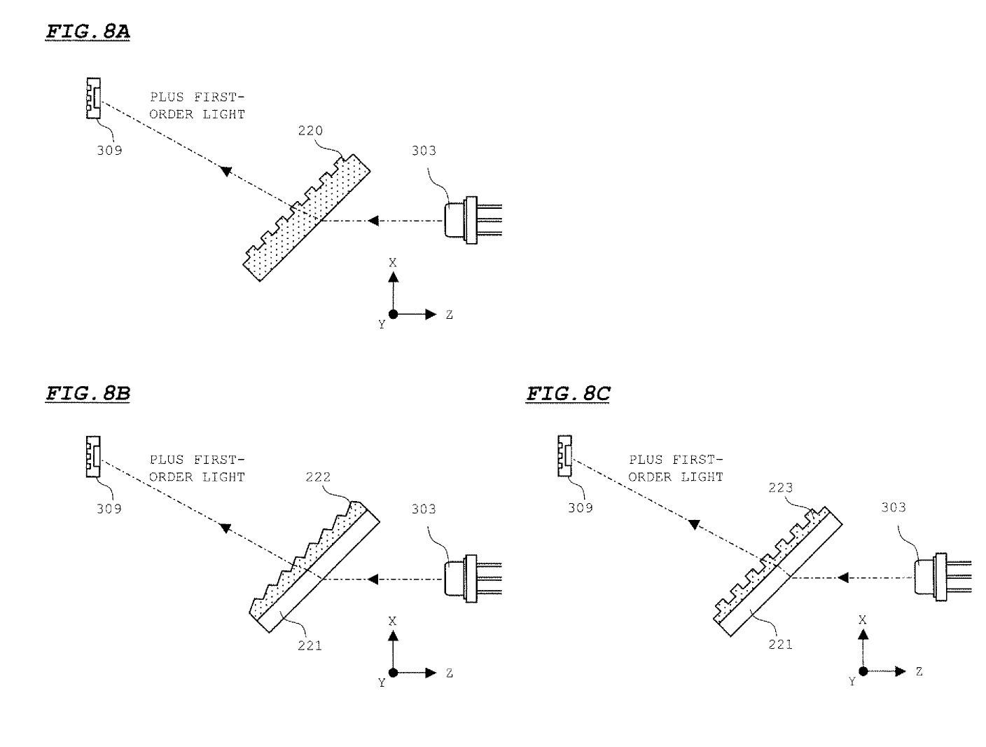

The hologram element 200 integrally formed with a blazed diffraction pattern is used in the embodiment. Alternatively, as shown in FIG. 8A, a hologram element 220 having a stepped diffraction pattern may be used in place of the hologram element 200.

Similarly to the embodiment, in the above modification, the hologram element 220 is integrally formed with a diffraction pattern for diffracting incident servo light in an in-plane direction of X-Z plane. Further, the servo light is divided into zero-order light, plus first-order light, and minus first-order light by the hologram element 220. Since the diffraction efficiency and the diffraction angle are respectively determined by the step height and the pitch width of the diffraction pattern, the positions of the diffraction pattern and the optical system may be set in advance in such a manner that plus first-order light is properly entered into the PSD 309.

Further alternatively, as shown in FIG. 8B, a hologram element 222 having a blazed diffraction pattern may be integrally formed on an exit surface of a transparent member 221 by adhesion or molding a UV curable resin, in place of the hologram element 200 described in the embodiment.

Similarly to the embodiment, in the above modification, the hologram element 222 has a diffraction pattern for diffracting incident servo light in an in-plane direction of X-Z plane. Accordingly, servo light to be entered into the transparent member 221 has its propagating direction changed by a refraction function of the transparent member 221, and refracted and diffracted by the hologram element 222. Servo light is divided into zero-order light (not shown) and plus first-order light by the diffraction function, and the plus first-order light is received by the PSD 309. As a result of the above operation, substantially the same effect as the embodiment can be obtained, although the number of parts is increased, as compared with the embodiment.

Further alternatively, as shown in FIG. 8C, a hologram element 223 having a stepped diffraction pattern may be provided, in place of the hologram element 222 having a blazed diffraction pattern as shown in FIG. 7B.

In the arrangements of the embodiment and FIG. 8A, a diffraction pattern is formed on the exit surface of each of the hologram element 200 and the hologram element 220. Alternatively, a diffraction pattern may be formed on an incident surface of each of the hologram element 200 and the hologram element 220. In the arrangements shown in FIGS. 8B and 8C, each of the hologram element 222 and the hologram element 223 is integrally formed on the exit surface of the transparent member 221. Alternatively, each of the hologram element 222 and the hologram element 223 may be integrally formed on the incident surface of the transparent member 221.

The PSD 309 is used as a photodetector for receiving servo light in the embodiment. Alternatively, a four-division sensor may be used in place of the PSD 309.

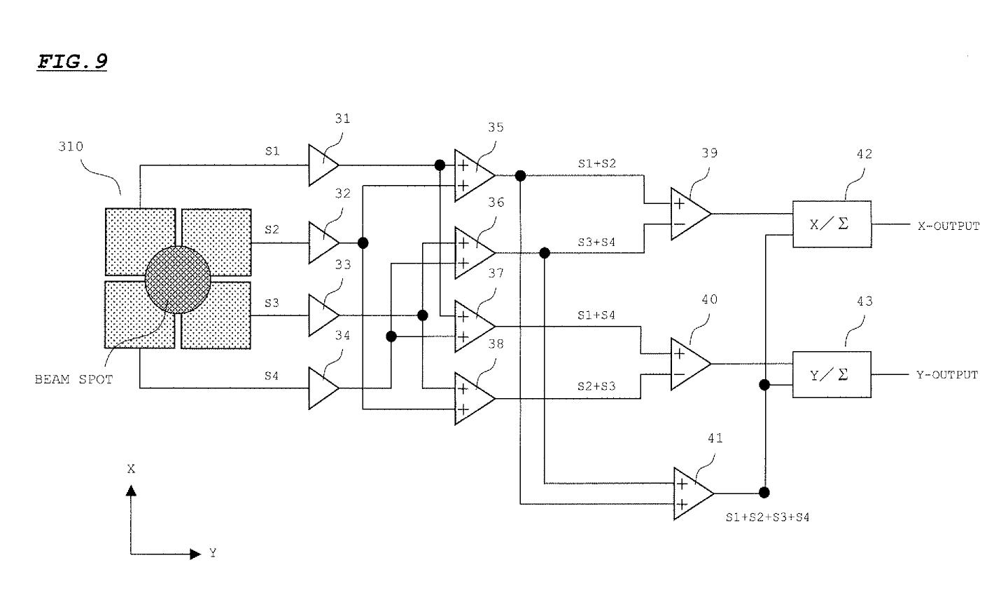

FIG. 9 is a diagram showing an arrangement, in the case where a four-division sensor 310 is used as a photodetector for receiving servo laser light. Servo laser light is irradiated onto a middle position of the four-division sensor 310, in the case where the mirror 113 is set to a neutral position. An X-directional position and a Y-directional position of a beam spot can be calculated by e.g. the following equations (5) and (6):

$$\begin{matrix}\frac{( S 1 + S 2 ) - ( S 3 + S 4 )}{S 1 + S 2 + S 3 + S 4} = x & ( 5 ) \\ \frac{( S 1 + S 4 ) - ( S 2 + S 3 )}{S 1 + S 2 + S 3 + S 4} = y & ( 6 )\end{matrix}$$

where S1, S2, S3, and S4 are output signals from sensing portions of the four-division sensor 310, as shown in FIG. 9.

FIG. 9 also shows an arrangement of a computation circuit for realizing the above equations (5) and (6). The signals S1, S2, S3, and S4 to be outputted from the sensing portions of the four-division sensor 310 are amplified by amplifiers 31, 32, 33, and 34, respectively. Then, computations (S1+S2), (S3+S4), (S1+S4), and (S2+S3) are performed by adder circuits 35, 36, 37, and 38, respectively. Then, computations (S1+S2)−(S3+S4) and (S1+S4)−(S2+S3) are performed by subtraction circuits 39 and 40, respectively. Further, a computation (S1+S2+S3+S4) is performed by an adder circuit 41. Then, divisions as shown by the left-hand members of the equations (5) and (6) are performed by divider circuits 42 and 43, respectively. Accordingly, position detection signals indicating a light receiving position of servo laser light in X direction and Y direction are outputted from the divider circuits 42 and 43, respectively.

In the above modification, signals (current signals) from the sensing portions may also be converted into voltage signals by I/V conversion, and position detection signals representing a light receiving position may be generated based on the voltage signals after I/V conversion by computations substantially equivalent to the foregoing computations.

The hologram element 200 for diffracting servo light only in X-axis direction is used in the embodiment. Alternatively, it is possible to use a hologram element for diffracting servo light in Y-axis direction as well as in X-axis direction. In the modification, for instance, a diffraction pattern substantially the same as the aforementioned diffraction pattern is formed on the exit surface of the hologram element, and a diffraction pattern for diffracting servo light in Y-axis direction is formed on the incident surface of the hologram element. Further alternatively, another hologram element having a diffraction pattern for diffracting servo light in Y-axis direction may be integrally formed with the hologram element 200. The modification enables to enhance detection precision of servo light in Y-axis direction in addition to X-axis direction, because the scan width of servo light is increased in Y-axis direction as well as X-axis direction.

In the foregoing embodiment, described is a beam irradiation device for scanning a targeted area with laser light by pivotally moving a mirror. The invention is also applicable to a beam irradiation device for scanning a targeted area with laser light by pivotally moving a lens into which laser light is entered.

The optical system for use in position detection, as described in the embodiment and the modifications, is applicable to various detecting devices for detecting a pivotal position of an object which is pivotally moved about a predetermined axis, as necessary, other than the aforementioned beam irradiation device. In the modification, for instance, the hologram element is directly mounted on an object whose pivotal position is to be detected, or the hologram element is mounted on the object through an interconnecting member which is pivotally movable with a pivotal movement of the object. A light source for servo light is disposed at such a position that servo light is entered into the hologram element, and servo light transmitted through the hologram element is received on a PSD. Accordingly, in the similar manner as described in the embodiment and the modifications, the above modification enables to increase a scan width of servo light at the time of pivotally moving the object to thereby precisely detect a pivotal position of the object.

The embodiment of the invention may be changed or modified in various ways as necessary, as far as such changes and modifications do not depart from the scope of the present invention hereinafter defined.

What is claimed is:

1. A beam irradiation device comprising:
a laser light source for emitting laser light;
an actuator for pivotally moving an optical element into which the laser light is entered, thereby scanning a targeted area with the laser light;
a servo light source for emitting servo light;
a transparent member being pivotally moved with the pivotal movement of the optical element, and for receiving the servo light;
a photodetector for receiving the servo light transmitted through the transparent member to output a signal depending on a light receiving position of the servo light; and
a diffracting portion being pivotally moved with the transparent member, and for diffracting the servo light in a pivotal direction of the transparent member.

2. The beam irradiation device according to claim 1, wherein
the diffracting portion is a diffraction pattern integrally formed on a surface of the transparent member.

3. The beam irradiation device according to claim 1, wherein
the actuator pivotally moves the optical element about a first axis and a second axis perpendicular to the first axis, and
the diffracting portion diffracts the servo light at least in the pivotal direction of the transparent member, in the case where the optical element is pivotally moved about the first axis.

4. The beam irradiation device according to claim 1, wherein
the optical element is a mirror.

5. A position detecting device for detecting a pivotal position of an object, the position detecting device comprising:
a servo light source for emitting servo light;
a transparent member being pivotally moved with a pivotal movement of the object, and for receiving the servo light;
a photodetector which receives the servo light transmitted through the transparent member to output a signal depending on a light receiving position of the servo light; and
a diffracting portion being pivotally moved with the transparent member, and for diffracting the servo light in a pivotal direction of the transparent member.

6. The position detecting device according to claim 5, wherein
the diffracting portion is a diffraction pattern integrally formed on a surface of the transparent member.
